(19) United States
(12) Patent Application Publication
(10) Pub. No.: US 2020/0071166 A1
(43) Pub. Date: Mar. 5, 2020

(54) METHOD FOR PREPARING HIGH-PURITY CHLORINE DIOXIDE BY USING METHANOL AND HYDROGEN PEROXIDE AS REDUCING AGENT

(71) Applicant: GuangXi University, Nanning (CN)

(72) Inventors: Shuangfei WANG, Nanning (CN); Zhan LEI, Nanning (CN); Huang BINGGUI, Nanning (CN); Xu CUISHENG, Nanning (CN); Liu LIANGQING, No.12 Kexing Road (CN); Li ZHONGPING, Nanning (CN); Tan LANG, Nanning (CN)

(21) Appl. No.: 16/310,812

(22) PCT Filed: Aug. 30, 2018
(86) PCT No.: PCT/CN2018/000307

§ 371 Date: Dec. 17, 2018

(30) Foreign Application Priority Data
Aug. 30, 2018 (CN) PCT/CN2018/000307

(51) Int. Cl. C01B 11/02; C01D 5/02

(52) U.S. Cl. CPC C01B 11/026; C01D 5/02

(57) ABSTRACT

The invention discloses a method for preparing high-purity chlorine dioxide by using methanol and hydrogen peroxide as reducing agent. The method comprises: concentrated sulfuric acid and sodium chlorate solution are injected into the generator to form the reaction mother liquid. The reaction mother liquid shall be maintained a certain acidity, temperature and sodium chlorate content, and then it is reacted with the reducing agent (methanol and hydrogen peroxide) to produce chlorine dioxide gas and by-product sodium sulfate. The chlorine dioxide gas is cooled and absorbed by low temperature chilled water to obtain an aqueous solution of chlorine dioxide, and by-products are recycled. The chlorine dioxide solution produced by the aforementioned method has a 60-70% reduction in the Cl2 content and 14-20% reduction in sulfuric acid consumption than that of the chlorine dioxide produced by using a single methanol reducing agent, and the by-product produced is sodium sulfate, not sodium hydrogen sulfate, so neutralization reaction treatment is not required.

### TECHNICAL FIELD

The invention relates to a method for preparing high-purity chlorine dioxide by using methanol and hydrogen peroxide as reducing agent.

### BACKGROUND

Chlorine dioxide (ClO2) is an orange-yellow gas at normal temperature and pressure, and has a pungent smell similar to the mixture of chlorine and ozone. The boiling point is 11° C., freezing point is −59° C., and gas density at 11° C. is 3.09 g/m3. Gaseous ClO2 is unstable, when exposed to light or in contact with organic matter at high concentration; it will cause explosion and decomposition and produce oxygen and chlorine. In general, it is prepared and used on site. It is stable at room temperature diluted with air and steam to a volume below 12% or in a low-temperature aqueous solution, and the solubility in water decreases with increasing temperature. ClO2 has strong oxidizing capacity and can be used as bleaching agent for pulp and textiles, water treatment agent, air freshening agent and disinfectant for diet, epidemic prevention and sanitation.

At present, the commonly used method for industrial preparation of chlorine dioxide is mainly the sodium chlorate method, which uses methanol, hydrochloric acid, sodium chloride, hydrogen peroxide or sulfur dioxide as reducing agent, of which methanol used as reducing agent is the current leading preparation method, it has high production efficiency but the product contains a certain amount of chlorine gas, and the sulfuric acid consumption is high; furthermore, the generated by-product, sodium hydrogen sulfate, should be neutralized before being recycled.

### CONTENTS OF INVENTION

The technical problem to be solved by the present invention is to provide a method for preparing chlorine dioxide by using methanol and hydrogen peroxide as reducing agent, which can improve the product purity, and the generated by-product is crystallized directly in the form of sodium sulfate, sulfuric acid consumption is reduced.

The present invention solves the above technical problems in the following technical solutions:

The method for preparing high-purity chlorine dioxide by using methanol and hydrogen peroxide as reducing agent according to the invention comprises the following steps:

First step, the concentrated sulfuric acid and sodium chlorate solution are injected into the generator system to form a reaction mother liquid. The reaction mother liquid is maintained at an acidity of 5.8-6.2N, sodium chlorate content is 234-266 g/l, and temperature is maintained at 69-73° C.; the aforesaid generator system consists of a reactor and a reboiler connected by a circulation pipe;

Second step, the reducing agent is added into the reaction mother liquid to produce chlorine dioxide gas and by-product sodium sulfate. The reducing agent is composed of methanol and hydrogen peroxide. The ratio of methanol to hydrogen peroxide by mass percentage is: 60-70% of methanol: 30-40% of hydrogen peroxide;

Third step, the generated chlorine dioxide gas is cooled and absorbed by 4-10° C. chilled water to obtain the chlorine dioxide aqueous solution, and the by-product sodium sulfate is filtered, washed and recycled.

In the second step, the methanol is first diluted with demineralized water to a volume concentration of 20% and then added to the reaction mother liquid from the venturi pipe at the reboiler outlet.

In the second step, the hydrogen peroxide is first prepared as hydrogen peroxide solution with a mass concentration of 30% and then mixed with the sodium chlorate solution, and added to the reaction mother liquid from the reboiler inlet.

In the second step, the preferred ratio of methanol to hydrogen peroxide is: 66% of methanol:34% of hydrogen peroxide.

In the first step, the reactor is maintained vacuum and pressure is −78 to −82 kPa.

In the third step, the chlorine dioxide gas is discharged from the top of the reactor, and the mixed gas temperature of the chlorine dioxide gas and the steam generated by the reactor is 57-68° C. and is gradually cooled to 38-45° C. by the intercooler, and then enters the chlorine dioxide absorption tower, the chlorine dioxide aqueous solution is formed by chilled water spray and absorption.

According to the method of this invention, the concentrated sulfuric acid and sodium chlorate solution are injected into the generator to form the reaction mother liquid. The reaction mother liquid shall be maintained a certain acidity, temperature and sodium chlorate content, and then it is reacted with the reducing agent to produce chlorine dioxide gas and by-product sodium sulfate. The chlorine dioxide gas is cooled and absorbed by low temperature chilled water to obtain an aqueous solution of chlorine dioxide, and by-products are filtered, washed and recycled.

The reaction principle of the invention for producing chlorine dioxide:

ClO₃⁻+Cl⁻+H⁺→ClO₂+Cl.+H₂O (1)

Cl.+Cl.→Cl₂ (2)

Cl.+CH₃OH→Cl⁻+H₂O+COOH⁻ (3)

H₂O₂+Cl₂→H⁺+Cl.+O₂ (4)

Sodium chlorate reacts (1) in the acid medium to generate chlorine dioxide gas and chlorine radicals; methanol acts as reducing agent and reacts with chlorine radicals according to reaction (3), and converts chlorine radicals into chloride ions, thereby reducing or avoid the reaction (2) of chlorine radicals and generating chlorine gas, so that chloride ions can be reused throughout the reaction process. However, in actual production, since the reaction rate of the reaction (3) is insufficient to completely convert all of the chlorine radicals into chloride ions, the purity of chlorine dioxide prepared by using methanol as a reducing agent is not high. The invention uses hydrogen peroxide together with methanol as reducing agent to prepare chlorine dioxide, through reaction (4), chlorine gas is reduced to chloride ions by hydrogen peroxide, thus the generation of chlorine gas is greatly decreased and the purity of chlorine dioxide gas is improved.

The method of this invention adopts reducing agent consisting of methanol and hydrogen peroxide in proper proportions, and reacts with sodium chlorate in a titanium container under strong acid, certain temperature and vacuum conditions to continuously produce high-purity chlorine dioxide and by-product sodium sulfate; after cooling, ClO2 gas is absorbed by low-temperature chilled water to obtain the ClO2 solution with a certain concentration, and the by-product is filtered, washed and recycled.

The chlorine dioxide solution produced by the aforementioned method has a 60-70% reduction in the Cl2 content and 14-20% reduction in sulfuric acid consumption than that of the chlorine dioxide produced by using a single methanol reducing agent, and the by-product produced is sodium sulfate, not sodium hydrogen sulfate, so neutralization reaction treatment is not required.

### SPECIFIC EMBODIMENTS

The method of the present invention will be further described below with reference to the accompanying drawings and examples:

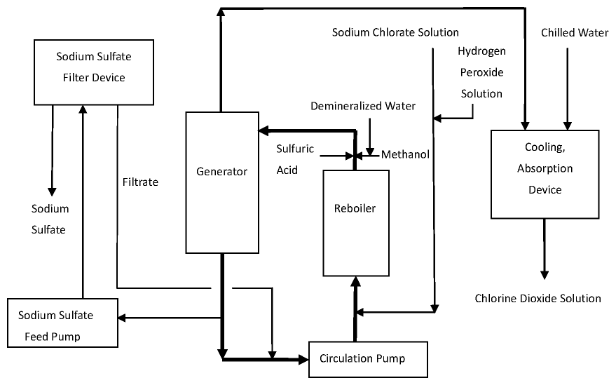

The process of the method of the invention is as shown in FIG. 1: concentrated sulfuric acid enters the generator from one side of the venturi pipe of the reboiler outlet, and methanol is diluted with demineralized water and then enters the generator from the other side of the venturi pipe. The hydrogen peroxide is mixed with the sodium chlorate solution and then enters the reboiler from the outlet pipe of the circulation pump, and enters the generator through the reboiler. The reaction liquid continuously circulates between the generator and the circulation pipe under the action of the circulation pump, and the reaction mother liquid is heated by the reboiler to maintain the temperature required for the reaction, and the generator and the reboiler are connected through the circulation pipe to form a circulation circuit.

With the addition of methanol and hydrogen peroxide, chlorine dioxide is continuously generated in the generator. The chlorine dioxide and the evaporated water vapor are discharged from the top of the generator into the intercooler, after cooled by the intercooler, they enter the chlorine dioxide absorption tower (the intercooler and the chlorine dioxide absorption tower are combined to form a cooling and absorption device). Chilled water is filled into the absorption tower to absorb chlorine dioxide to form the chlorine dioxide aqueous solution.

The solid content in the generator is controlled to a certain concentration range, and the produced sodium sulfate is pumped out together with the mother liquid from the bottom of the generator by the sodium sulfate feed pump, and sent to the sodium sulfate filter device for filtration and recycle, and the filtered mother liquid is returned to the generator.

In the present invention, the addition point of methanol is at the venturi pipe of the reboiler outlet, and the addition point of hydrogen peroxide is between the inlet of the reboiler and the outlet of the circulation pump.

### Example 1

186 kg of 98% mass concentrated sulfuric acid and 547 kg of 30% mass concentration sodium chlorate solution are injected into the generator to form a reaction mother liquid, which is circulating in the circulation pipe of the generator under the action of a circulation pump, and maintains at an acidity of 5.8-6.2N and a sodium chlorate content of 158-266 g/l. The heat is transferred to the mother liquid by a reboiler to maintain a temperature of 69-73° C. 20% (v/v) methanol with a weight of 44.8 kg and 30% (w/w) hydrogen peroxide with a weight of 16.3 kg are continuously and uniformly injected into the generator to produce chlorine dioxide. The generator maintains vacuum, pressure is −78 to −82 kPa(g). Under the negative pressure condition, the temperature of the mixed gas of chlorine dioxide and water vapor discharged from the generator is 57-68° C., and is preliminarily lowered to 38-45° C. by the intercooler, the gas enters the chlorine dioxide absorption tower and is sprayed with 4-10° C. chilled water to produce chlorine dioxide solution. By-products are generated and continue to form precipitated crystals in the mother liquor as the reaction progresses. To maintain the volume percentage of the solids in the reaction liquid is 18-23%, the mother liquid containing sodium sulfate is pumped out from the bottom of the generator, and the by-product sodium sulfate is filtered out by a filter, and the filtrate is returned to the generator. The concentration of the chlorine dioxide solution produced is 9.4 g/l, the Cl₂ content of the solution is 0.08 g/l, and the sulfuric acid consumption is 0.86 t/tClO₂.

### Example 2

186 kg of 98% mass concentration sulfuric acid and 547 kg of 30% mass concentration sodium chlorate solution are injected into the generator to form a reaction mother liquid, which is circulating in the circulation pipe of the generator under the action of a circulation pump, and maintains at an acidity of 5.8-6.2N and a sodium chlorate content of 158-266 g/l. The heat is transferred to the mother liquid by a reboiler to maintain a temperature of 69-73° C. 20% (v/v) methanol with a weight of 46.5 kg and 30% (w/w) hydrogen peroxide with a weight of 14.3 kg are continuously and uniformly injected into the generator to produce chlorine dioxide. The generator maintains vacuum, pressure is −78 to −82 kPa(g). Under the negative pressure condition, the temperature of the mixed gas of chlorine dioxide and water vapor discharged from the generator is 57-68° C., and is preliminarily lowered to 38-45° C. by the intercooler, the gas enters the chlorine dioxide absorption tower and is sprayed with 4-10° C. chilled water to produce chlorine dioxide solution. By-products are generated and continue to form precipitated crystals in the mother liquor as the reaction progresses. To maintain the volume percentage of the solids in the reaction liquid is 18-23%, the mother liquid containing sodium sulfate is pumped out from the bottom of the generator, and by-product sodium sulfate is filtered out by a filter, and the filtrate is returned to the generator. The concentration of the chlorine dioxide solution produced is 9.5 g/l, the Cl₂ content of the solution is 0.09 g/l, and the sulfuric acid consumption is 0.87 t/tClO₂.

1. A method for preparing high-purity chlorine dioxide by using methanol and hydrogen peroxide as reducing agent, characterized in that, it comprises the following steps:
First step, the concentrated sulfuric acid and sodium chlorate solution are injected into the generator system to form a reaction mother liquid. The reaction mother liquid is maintained at an acidity of 5.8-6.2N, sodium chlorate content is 234-266 g/l, and temperature is maintained at 69-73° C.; the aforesaid generator system consists of a reactor and a reboiler connected by a circulation pipe;
Second step, the reducing agent is added into the reaction mother liquid to produce chlorine dioxide gas and by-product sodium sulfate. The reducing agent is composed of methanol and hydrogen peroxide. The ratio of methanol to hydrogen peroxide by mass percentage is: 60-70% of methanol:30-40% of hydrogen peroxide;
Third step, the generated chlorine dioxide gas is cooled and absorbed by 4-10° C. chilled water to obtain the chlorine dioxide aqueous solution, and the by-product sodium sulfate is filtered, washed and recycled.

2. A method for preparing high-purity chlorine dioxide by using methanol and hydrogen peroxide as reducing agent according to claim 1, wherein in the second step, the methanol is first diluted with demineralized water to a volume concentration of 20% and then added to the reaction mother liquid from the venturi pipe at the reboiler outlet.

3. A method for preparing high-purity chlorine dioxide by using methanol and hydrogen peroxide as reducing agent according to claim 2, wherein in the second step, the hydrogen peroxide is first prepared as hydrogen peroxide solution with a mass concentration of 30% and then mixed with the sodium chlorate solution, and added to the reaction mother liquid from the reboiler inlet.

4. A method for producing high-purity chlorine dioxide by using methanol and hydrogen peroxide as reducing agent according to claim 2, wherein in the first step, the reactor is maintained vacuum and pressure is −78 to −82 kPa.

5. A method for preparing high-purity chlorine dioxide by using methanol and hydrogen
peroxide as reducing agent according to claim 2, wherein in the third step, the chlorine dioxide gas is discharged from the top of the reactor, and the mixed gas temperature of the chlorine dioxide gas and the steam generated by the reactor is 57-68° C. and is gradually cooled to 38-45° C. by the intercooler, and then enters the chlorine dioxide absorption tower, the chlorine dioxide aqueous solution is formed by spraying and absorption of chilled water.

6. A method for preparing high-purity chlorine dioxide by using methanol and hydrogen peroxide as reducing agent according to claim 2, wherein in the second step, the preferred ratio of the methanol to hydrogen peroxide is: 66% of methanol:34% of hydrogen peroxide.
